(19) United States
(12) Patent Application Publication
(10) Pub. No.: US 2004/0246232 A1
(43) Pub. Date: Dec. 9, 2004

(54) Optic mouse

(75) Inventors: Wei Chang, San Chung City (TW); Hsien-Yeh Hung, San Chung City (TW)

Correspondence Address: TROXELL LAW OFFICE PLLC, SUITE 1404, 5205 LEESBURG PIKE, FALLS CHURCH, VA, 22041, US

(73) Assignee: Unity Opto Technology Co., Ltd.

(21) Appl. No.: 10/455,380

(22) Filed: Jun. 6, 2003

(51) Int. Cl. G09G 5/08

(52) U.S. Cl. 345/163

(57) ABSTRACT

An optic mouse includes a housing having a bottom casing and a top cover mounted to the bottom casing, a circuit board mounted in the housing and a splitter mounted on the bottom casing. The bottom casing defines an opening. A detecting device is mounted to the circuit board and has a receiving portion in alignment with the opening of the bottom casing. A laser source is arranged on one side of the detecting device. The splitter has top and bottom faces respectively opposing the receiving portion of the detecting device and the opening of the bottom casing and a side face opposite to the laser source. By this, a light beam from the laser source is made convergent and is prevented from divergence by making use of the polarity characteristics of the light from the laser source and the splitter. Excellent operability of the mouse can be realized.

### FIELD OF THE INVENTION

The present invention generally relates to an optic mouse, and in particular to an optic mouse comprising a splitter for directing a projected light toward a fixture surface and transmitting the reflected light to a detector by making use of polarity characteristics of the light emitted from a laser source.

### BACKGROUND OF THE INVENTION

Conventionally, a computer mouse comprises a bottom casing and a top cover mounted to the bottom casing, defining an interior space therebetween for accommodating a circuit board. The circuit board is fixed to the bottom casing and comprises a tracking module substantially aligned with an opening defined in the bottom casing. The tracking module comprises a track ball rotatably mounted inside the mouse and partially projects through the opening beyond the bottom casing for engaging a fixture surface on which the mouse is moved. The track ball is rotated when the mouse moves on the fixture surface. The rotation of the track ball is converted into electrical signal that is transmitted through an electrical cable soldered to the circuit board to a host computer.

Due to the opening defined in the bottom casing, debris and dusts may be drawn into the mouse by the rotation of the track ball. This leads to poor engagement between components of the mouse in generating and transmission of the signal indicating the movement of the mouse.

An optic mouse overcomes at least the dust problem by generating the movement signal of the mouse by means of detection of reflection light. The optic mouse comprises a bottom casing and a top cover attached to the bottom casing with a circuit board received between the bottom casing and the top cover and fixed to the bottom casing. An illuminating element, such as a light emitting diode (LED), is mounted to the circuit board for projecting a light beam through an opening defined in the bottom casing. The light beam is reflected by a fixture surface on which the mouse is moved. The reflected light beam transmits through the opening of the casing, as well as a slot defined in the circuit board, and detected by a sensor mounted on the circuit board and substantially aligned with the opening. An optic arrangement is positioned between the circuit board and bottom casing, comprising first and second lenses that are integrally formed with and substantially perpendicular to each other. The first lens is in alignment with the illuminating element, while the second lens corresponds in position to the sensor. A light beam projected from the illuminating element is refracted by the first lens to the fixture surface and reflected by the fixture surface toward the second lens through which the reflected beam is detected by the sensor.

The conventional optic mouse effectively overcomes the dust problems of the mechanical mouse. However, the light beam from the illuminating element must travel along a path extending through the first lens, reflected by the fixture surface and then extending through the second lens before it is detected. Conventionally, the light is emitted in a radiating manner whereby a divergence of the light is commonly observed. The light may get further diverged when passing through the lenses and being reflected by the fixture surface. Therefore, the sensor may not properly detect the reflected light, leading to poor operation of the optic mouse.

### SUMMARY OF THE INVENTION

Therefore, a primary object of the present invention is to provide an optic mouse comprising a splitter, which, together with the polarity characteristics of the light emitted by a laser source, effectively prevents the light from divergence and thus realizing excellent operability of the mouse.

To achieve the above object, in accordance with the present invention, there is provided an optic mouse comprising a housing comprising a bottom casing and a top cover mounted to the bottom casing, the bottom casing defining an opening; a circuit board received in the housing and comprising a detecting device having a receiving portion substantially aligned with the opening of the bottom casing, a laser source being mounted at one side of the detecting device; and a splitter mounted on the bottom casing of the housing, the splitter having top and bottom faces respectively opposing the receiving portion of the detecting device and the opening of the bottom casing, the splitter having a side face opposing the laser source. By making use of the polarity characteristics of the light emitted from the laser source and the splitter, the light is made convergent and is prevented from divergence whereby excellent operability of the mouse can be realized.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded view of an optic mouse constructed in accordance with the present invention;

FIG. 2 is a cross-sectional view of a portion of the mouse in accordance with the present invention; and

FIG. 3 is a cross-sectional view similar to FIG. 2 and showing a light path of a light beam generated by the mouse.

### DETAILED DESCRIPTION OF THE PREFERRED EMBODIMENT

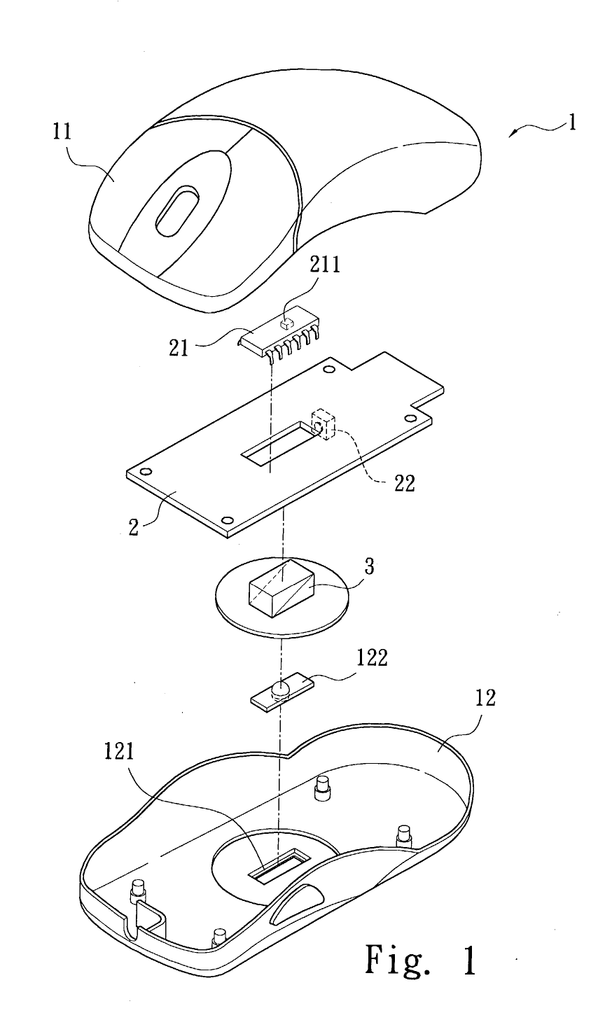

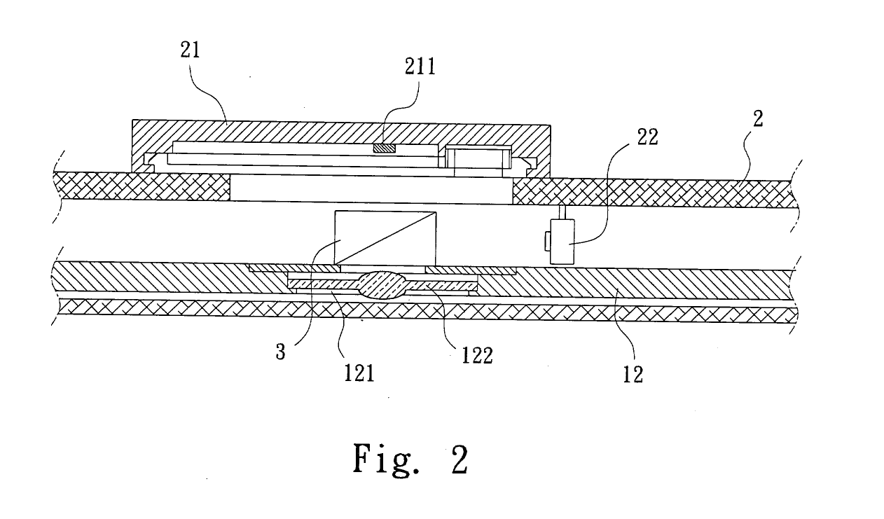

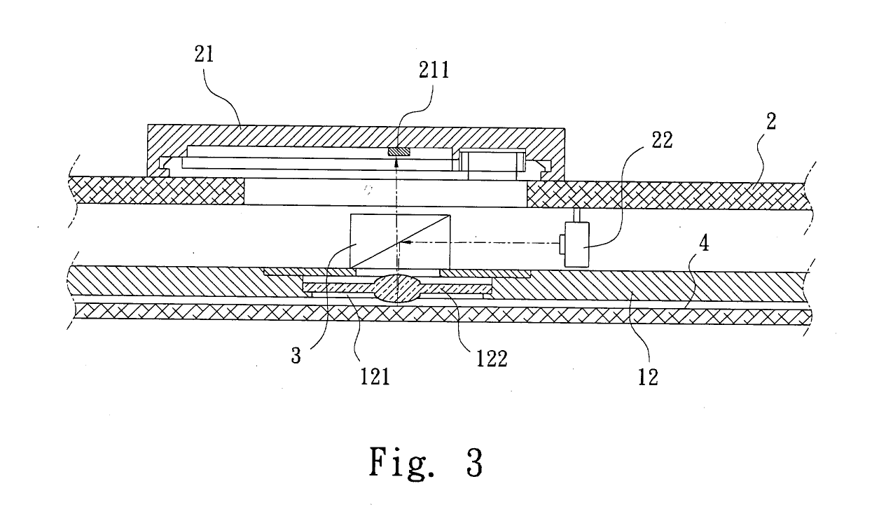

With reference to the drawings and in particular to FIGS. 1 and 2, an optic mouse constructed in accordance with the present invention comprises a housing 1 in which a circuit board 2 and a splitter 3 are mounted. The circuit board 2 comprises a laser source 22 emitting a light beam or an optic signal possessing polarity characteristics, which together with the splitter 3, allows for convergence of the light beam and eliminates divergence of the light when the light beam travels along a path as indicated by phantom lines shown in FIG. 3.

The housing 1 comprises a bottom casing 12 to which a top cover 11 is mounted, defining an interior space therebetween for accommodating the circuit board 2 and the splitter 3. The bottom casing 12 defines an opening 121.

The circuit board 2 is fixed in the housing 1. A detecting device 21 is mounted on the circuit board 2. On a bottom side of the detecting device 21, a receiving portion 211 is formed and located in alignment with the opening 121 of the bottom casing 12. The laser source 22 is arranged at one side of the detecting device 21.

The splitter 3 is mounted to the bottom casing 12 of the housing 1, having top and bottom faces respectively opposing the receiving portion 211 of the detecting device 21 and the opening 121 of the bottom casing 12. The splitter 3 is positioned so that one side face of the splitter 3 is opposite to the laser source 22. A focusing lens 122, such as a convex lens, is mounted to and completely covering the opening 121 of the bottom casing 12 whereby the focusing lens 122 is located below the splitter 3. The focusing lens 122 effectively converges the light beam transmitting therethrough, as well as preventing foreigner objects from getting into the housing 1. Also, anti-static charge and other electrical interference can be realized.

Also referring to FIG. 3, an optic signal emitted from the laser source 22 transmits into the splitter 3 through the side face of the splitter 3. The splitter 3 reflects the optic signal in a direction toward the opening 121 of the bottom casing 12. Thus, the optic signal transmits through the focusing lens 122 toward a fixture surface 4, such as a desk or a mouse pad, on which the mouse 1 is moved. The optic signal is then reflected by the fixture surface 4, traveling through the focusing lens 122 again and getting concentrated by the focusing lens 122. The reflected optic signal transmits directly through the splitter 3 and reaches the receiving portion 211 of the detecting device 21 and detected thereby. By means of the polarity characteristics of the optic signal from the laser source 22 and the splitter 3, the optic signal is reflected by the splitter 3 to the fixture surface and, after being reflected by the fixture surface, due to change of polarity characteristics, is allowed to directly transmit through the splitter 3 to reach the detecting device 21.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An optic mouse comprising:
a housing comprising a bottom casing and a top cover mounted to the bottom casing, the bottom casing defining an opening;
a circuit board received in the housing and comprising a detecting device having a receiving portion substantially aligned with the opening of the bottom casing, a laser source being mounted at one side of the detecting device; and
a splitter mounted on the bottom casing of the housing, the splitter having top and bottom faces respectively opposing the receiving portion of the detecting device and the opening of the bottom casing, the splitter having a side face opposing the laser source.

2. The optic mouse as claimed in claim 1 further comprising a convex lens mounted to the opening of the bottom casing whereby the convex lens is located below the splitter.
